(19) United States
(12) Patent Application Publication
(10) Pub. No.: US 2016/0292233 A1
(43) Pub. Date: Oct. 6, 2016

(54) DISCARDING DATA POINTS IN A TIME SERIES

(71) Applicant: HEWLETT PACKARD ENTERPRISE DEVELOPMENT LP, Houston, TX (US)

(72) Inventors: William K. Wilkinson, San Mateo, CA (US); Alkiviadis Simitsis, Santa Clara, CA (US)

(73) Assignee: HEWLETT PACKARD ENTERPRISE DEVELOPMENT LP, Houston, TX (US)

(21) Appl. No.: 15/034,369

(22) PCT Filed: Dec. 20, 2013
(86) PCT No.: PCT/US2013/076784

§ 371 Date: May 4, 2016

(51) Int. Cl. G06F 17/30

(52) U.S. Cl. CPC G06F 17/30551; G06F 17/3053; G06F 17/30303

(57) ABSTRACT

Described herein are techniques for determining which data points in a time series to discard. A time series may include multiple data points. Spaced intervals over the time series may be determined. The data points can be ranked at least in part based on their respective distance from a nearest spaced interval. A data point may be discarded based on the ranking.

### REFERENCE TO RELATED APPLICATIONS

This application is related to International Patent Application No. PCT/US13/______, filed on Dec. 20, 2013 and entitled “Generating a visualization of a metric at a level of execution”, and International Patent Application No. PCT/US13/______, filed on Dec. 20, 2013 and entitled “Identifying a path in a workload that may be associated with a deviation”, both of which are hereby incorporated by reference.

### BACKGROUND

Time series data includes data points generated over a period of time. The data points may be generated by one or more processes (e.g., sensors, computer systems) and may be multivariate. The data points may represent various information, such as sensor readings, metric values, time stamps, etc. The data may be voluminous.

Time series data may be received in a continuous stream. A system receiving the time series data may not know beforehand how many data points a particular stream will include. This may be because it is unknown how long the process generating the time series data will run. A system receiving the time series data may run out of resources (e.g., storage) for storing and/or processing the time series data.

### BRIEF DESCRIPTION OF DRAWINGS

The following detailed description refers to the drawings, wherein:

FIG. 1 illustrates a method of processing time series data, according to an example.

FIG. 2 illustrates a method of retaining a sample of data points in a times series, according to an example.

FIG. 3 illustrates an example of retaining a sample of data points in a time series by determining spaced intervals, according to an example,

FIG. 4 illustrates a system for retaining a sample of data points in a time series, according to an example.

FIG. 5 illustrates a computer-readable medium for discarding data points in a time series, according to an example.

### DETAILED DESCRIPTION

Time series data may be generated by various systems and processes. For example, query or workflow execution engines may generate numerous metric measurements (e.g., execution time, elapsed time, rows processed, memory allocated) during execution of a query or workflow. Network monitoring applications, industrial processes (e.g., integrated chip fabrication), and oil and gas exploration systems are other examples of systems and processes that may generate time series data. The time series data may be useful for various reasons, such as serving as a representation of the behavior of the system for later analysis.

Time series data can be received in a continuous stream from an active system or process. The time series data can be received at a system for storing and eventually processing and analyzing the data. However, the receiving system may not know beforehand how much time series data it will receive because it may not know how long the data generating system/process will be active. For example, time series data relating to execution of a query can be received by a query monitoring system from a query execution engine. The query monitoring system may not know how long the query execution engine will take to execute the query. As a result, the query monitoring system may not know how much storage is needed to store all of the time series data and/or may reach a storage limit while still receiving additional data points.

According to an example implementing the techniques described herein, while receiving a stream of time series data, each received data point may be stored until a limit (e.g., storage limit) is reached. Upon receiving each additional data point in the time series, a retention process may be performed. The retention process may include retaining a first received data point and a most recently received data point. These may be retained due to a constraint that the first and last data points in the times series should be retained. Spaced intervals may be determined over the time series. Each remaining data point may then be ranked. Each data point's rank may be based at least in part on the data point's distance from the data point's nearest spaced interval. A data point may be discarded based on its ranking. In some examples, a data point's rank may also be based on other characteristics of the data point, such as whether it is a minimum value, a maximum value, or an inflexion point in the time series for one or more metrics.

As a result, a fairly uniform sample of the time series may be retained in accordance with storage limits. The sample may approximate a sample that would have otherwise been obtained with complete a priori knowledge of the time series. Additionally, data points having particular significance to the times series may also be retained. Additional examples, advantages, features, modifications and the like are described below with reference to the drawings.

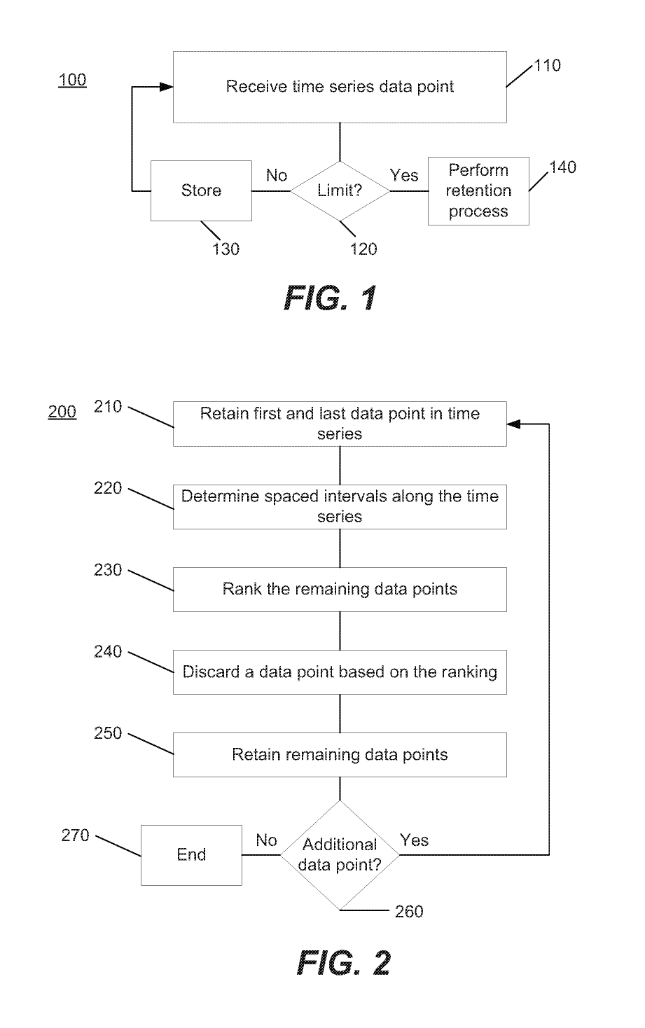

FIG. 1 illustrates a method for processing time series data, according to an example. FIG. 2 illustrates a method of retaining a sample of data points in a times series, according to an example. Methods 100 and 200 may be performed by a computing device, system, or computer, such as system 410 or computer 510. Computer-readable instructions for implementing methods 100 and 200 may be stored on a computer readable storage medium. These instructions as stored on the medium are referred to herein as “modules ”and may be executed by a computer.

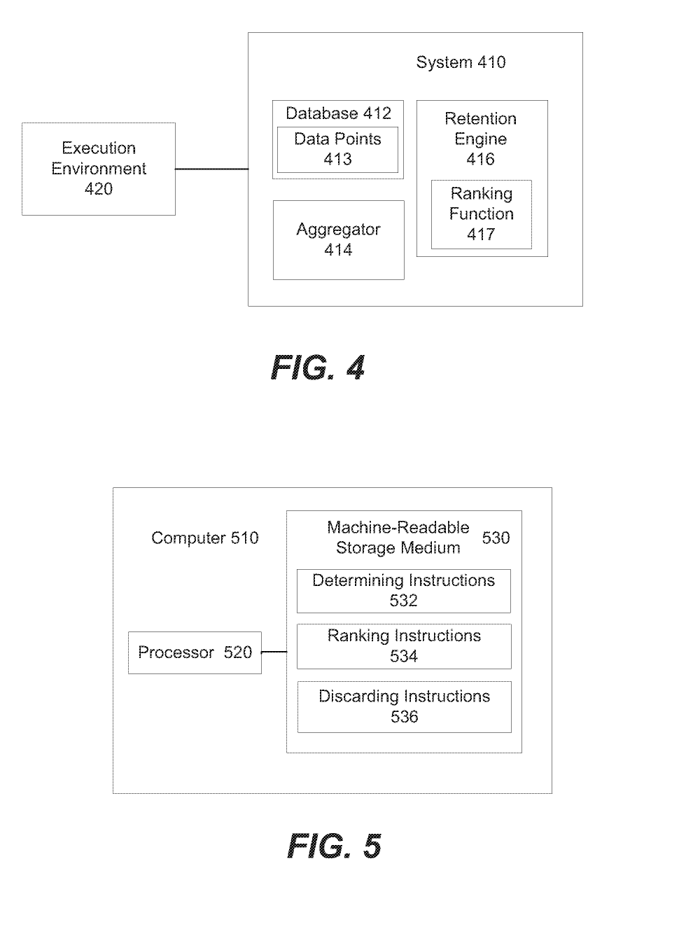

Methods 100 and 200 will be described here relative to system 410 of FIG. 4. System 410 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 410 may include one or more machine-readable storage media separate from the one or more controllers.

System 410 may include a number of components. For example, system 410 may include a database 412 for storing data points 413, an aggregator 414, and a retention engine 416 which can implement ranking function 417. System 410 may be connected to execution environment 420 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing. The components of system 410 may also be connected to each other via a network.

Method 100 may begin at 110, a time series data point may be received. The time series data point may be part of a continuous stream of time series data. The time series data may be generated by any of various systems and processes. For example, query or workflow execution engines may generate numerous metric measurements (e.g., execution time, elapsed time, rows processed, memory allocated) during execution of a query or workflow. Network monitoring applications, industrial processes (e.g., integrated chip fabrication), and oil and gas exploration systems are other examples of systems and processes that may generate time series data. The time series data may represent various information, such as sensor readings, metric values, time stamps, etc. The time series data may be univariate or multivariate. If the time series data is multivariate, each data point may represent multiple readings, metric values, etc.

Here, methods 100 and 200 are described with reference to an example in which the time series data comprises multiple measurements relating to the execution of a workload in execution environment 420.

Execution environment 420 can include an execution engine and a storage repository of data. An execution engine can include one or multiple execution stages for applying respective operators on data, where the operators can transform or perform some other action with respect to data. A storage repository refers to one or multiple collections of data. An execution environment can be available in a public cloud or public network, in which case the execution environment can be referred to as a public cloud execution environment. Alternatively, an execution environment that is available in a private network can be referred to as a private execution environment.

As an example, execution environment 420 may be a database management system (DBMS). A DBMS stores data in relational tables in a database and applies database operators (e.g. join operators, update operators, merge operators, and so forth) on data in the relational tables. An example DBMS environment is the HP Vertica product.

A workload may include one or more operations to be performed in the execution environment. For example, the workload may be a query, such as a Structured Language (SQL) query. The workload may be some other type of workflow, such as a Map-Reduce workflow to be executed in a Map-Reduce execution environment or an Extract-Transform-Load (ETL) workflow to be executed in an ETL execution environment.

Each time series data point may represent one or more measurements of metrics relating to execution of the workload. For example, the metrics may include performance metrics like elapsed time, execution time, memory allocated, memory reserved, rows processed, and processor utilization. The metrics may also include other information that could affect workload performance, such as network activity or performance within execution environment 420. For instance, poor network performance could adversely affect performance of a query whose execution is spread out over multiple nodes in execution environment 420. Additionally, estimates of the metrics for the workload may also be available. The estimates may indicate an expected performance of the workload in execution environment 420. Having the estimates may be useful for evaluating the actual performance of the workload.

The metrics (and estimates) may be retrieved or received from the execution environment 420 by system 410. The metrics may be measured and recorded at set time intervals by monitoring tools in the execution environment. The measurements may then be retrieved or received periodically, such as after an elapsed time period (e.g., every 4 seconds). Alternatively, the measurements could be retrieved all at once after the workload has been fully executed. The metrics may be retrieved from log files or system tables in the execution environment.

At 120, it may be determined whether a limit has been reached. For example, the limit may be a storage limit or storage allocation limit. For example, if there are only sufficient storage resources to store 1K data points in the time series and method 100 has just received data point 1001, then the storage limit has been reached. If the limit has not been reached (“no” at 120), method 100 may proceed to 130 and the received time series data point may be stored in database 412. If the limit has been reached (“yes” at 120), method 100 may proceed to 140 and a retention process may be performed. The retention process may be performed by retention engine 416.

Turning to FIG. 2, method 200 illustrates a retention process for retaining a sample of time series data, according to an example. Method 200 may begin at 210, where a first and last data point in the time series may be retained. This may be performed to satisfy a constraint that the first and last data points in the time series should be retained. In determining the first and last data points to be retained, the last data point is the data point having the most recent time stamp, which likely will be the most recently received data point. The first data point is the data point with the earliest time stamp in the entire series. This can be determined by examining the data points 413 stored in database 412.

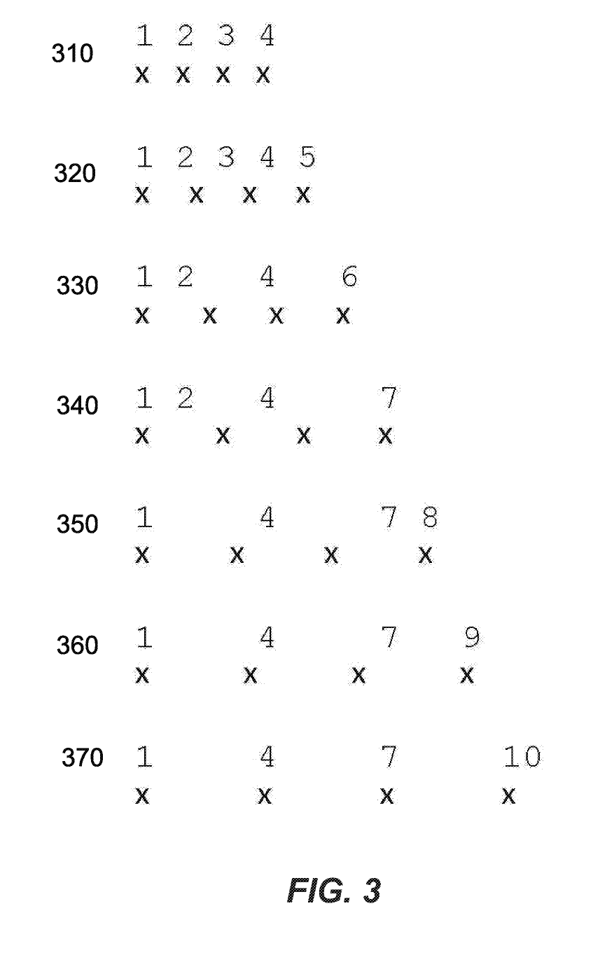

At 220, spaced intervals may be determined along the time series. The spaced intervals may be substantially equal spaced time intervals over the time series, between the first data point and the last data point. For example, the spaced intervals may be determined using the following equation:

$$i = \frac{b - a}{n - 1}$$

where i is the interval spacing, b is the time stamp of the last data point, a is the time stamp of the first data point, and n is the number of data points that may be retained before reaching the limit. The spaced intervals may be determined by adding the interval spacing i to the time stamp of the first data point a for (n−2) times. This will be illustrated in more detail shortly with reference to FIG. 3.

At 230, the remaining data points (i.e., the available data points other than the first and the last data points in the time series) may be ranked based on one or more attributes. Retention engine 416 may perform the ranking using ranking function 417. For example, each data point may be ranked based on its distance from its nearest spaced interval. The larger the distance from the nearest spaced interval, the worse rank the data point will receive. In one example, a higher rank corresponds to a worse rank. Of course, the ranking could be configured so that a lower ranking corresponds to a worse rank.

The data points may also be ranked based on other attributes. For example, each data point or a subset of the data points (e.g., only the worse ranked data points according to the spaced interval ranking) could be ranked based on whether the data point has a characteristic, where the ranking is improved if the data point has the characteristic. The characteristic may be a measure of how interesting or informative the data point is relative to the other data points in the time series. Example characteristics include whether the data represents a maximum value, a minimum value, or an inflexion point (a significant deviation from surrounding data points) for one or more metrics. For example, suppose a data point is multivariate and includes measurements for memory usage and temperature readings. If the data point represents a minimum value, maximum value, or inflexion point for memory usage or temperature readings, its rank could be improved to reflect this. This could be beneficial because retaining data points with those types of characteristics may assist in analysis of the performance of the system generating the time series data. Additionally, if the data point represents more than one of these characteristics, its rank may be improved even more. This may be useful in case all remaining data points have some characteristic.

In addition, the characteristic may be based on pre-defined variances, such as variances defined by a user. Thus, instead of taking into account only metric measures, retention engine may consider functions over the measures or even constraints related to these. For example, a reading at time point t may be interesting if at that point the measures for variances x and y are above/below a threshold. Or it is possible to incorporate in the function information stored in a persistent storage. For instance, a data point may be interesting if at a time point t two measures x and y have values above/below the z% of the values observed for similar executions (e.g., same queries or same operators in queries) in a certain time period in the past (e.g., in the last month or in a window equal to the uptime of the system).

It may also be determined whether a data point has a characteristic at any of multiple levels of execution. A level of execution as used herein is intended to denote an execution perspective through which to view the metric measurements. Where the workload is a query, example levels of execution include a query level, a query phase level, a path level, a node level, a path level, and an operator level. These will be illustrated through an example where HP Vertica is the execution environment 420.

Monitoring tools in the HP Vertica engine collect metrics for each instance of each physical operator in the physical execution tree of a submitted query. The measurements of these metrics at the physical operator level correspond to the “operator level”. Second, from a user perspective, the query execution plan is the tree of logical operators (referred to as paths in HP Vertica) shown by the SQL explain plan command. Each logical operator (e.g., GroupBy) comprises a number of physical operators in the physical execution tree (e.g., ExpressionEval, HashGroupBy). Accordingly, the metric measurements may be aggregated at the logical operator level, which corresponds to the “path level”. Third, a physical operator may run as multiple threads on a node (e.g., a parallel tablescan). Additionally, because HP Vertica is a parallel database, a physical operator may execute on multiple nodes. Thus, the metric measurements may be aggregated at the node level, which corresponds to the “node level”.

Fourth, a phase is a sub-tree of a query plan where all operators in the sub-tree may run concurrently. In general, a phase ends at a blocking operator, which is an operator that does not produce any output until it has read all of its input (or, all of one input if the operator has multiple inputs, like a join). Examples of blocking operators are Sort and Count. Accordingly, the metric measurements may be aggregated at the phase level, which corresponds to the “query phase level”. Fifth, the metric measurements may be reported for the query as a whole. Thus, the metric measurements may be aggregated at a top level, which corresponds to the “query level”.

The time series data may be aggregated by aggregator 414 at these multiple levels of execution. Consequently, metric measurements as interpreted by aggregator 414 form a multi-dimensional, hierarchical dataset where the dimensions are the various levels of execution. The metrics may then be considered at the operator level, the path level, the node level, the query phase level, and the query level.

By determining whether a data point has a characteristic at one or more additional levels of execution, potentially interesting data points are able to be preserved. This is because although a data point may not have a characteristic at a higher level, such as query level or query phase level, it may have the characteristic at a lower level, such as node level. Not all levels of execution have to be examined. Rather, as with the other attributes, retention engine 416 and ranking function 417 may be configured to examine each data point to meet the ultimate purpose of the analysis that will be performed on the time series data.

At 240, retention engine 416 may discard a data point based on its rank. For example, where a higher rank indicates a worse rank, the highest ranked data point may be discarded. At 250, the remaining data points may be retained in database 412. At 260, it may be determined whether another data point has been received. If another data point has been received (“yes” at 260), method 200 may proceed to 210 and method 200 may be repeated. If another data point has not been received (“no” at 260), method 200 may proceed to 270 and terminate.

FIG. 3 illustrates an example of retaining a sample of a time series by determining spaced intervals, according to an example. Suppose it is desired to maintain a sample size of 4 data points for an incoming time series. For example, the memory limit may allow only a maximum of 4 data points to be retained at any one time. The data points arrive every second. Note that it is unknown how many data points will arrive in this time series. Although 10 total data points are shown in the figure, more data points could continue to arrive and the method could continue. In the figure, the integers denote the time stamps of the data points and the “x”40 s denote the substantially equally spaced intervals.

At 310, the first four data points arrive. Because the memory limit is 4, these first four data points are able to be retained. At 320, data point 5 arrives. Data points 1 and 5 are retained because they are the first and last data points in the time series. The interval is determined using the previously presented equation, which is reproduced here for convenience:

$$i = \frac{b - a}{n - 1}$$

where i is the interval spacing, b is the time stamp of the last data point, a is the time stamp of the first data point, and n is the number of data points that may be retained before reaching the limit.

Thus, the interval is 1.33 (rounded). Accordingly, the spaced intervals are 2.33 and 3.66. To determine which of the remaining data points to discard, the distance of each one from its nearest spaced interval is determined. Data point 2 is 0.33 away from its nearest spaced interval (2.33). Data point 3 is 0.66 away from its nearest spaced interval (3.66). Data point 4 is 0.34 away from its nearest spaced interval (3.66). Accordingly, data point 3 is the farthest from its nearest spaced interval. Data point 3 is thus dropped, as shown in 320.

At 330, data point 6 arrives. Data points 1 and 6 are retained as the first and last data points in the time series. The interval is 1.66 (rounded). The spaced intervals are thus 2.66 and 4.32. Data point 2 is 0.66 away from its nearest spaced interval (2.66). Data point 4 is 0.32 away from its nearest spaced interval (4.32). Data point 5 is 0.68 away from its nearest spaced interval (4.32). Accordingly, data point 5 is the farthest from its nearest spaced interval. Data point 5 is thus dropped.

This same analysis continues through steps 340 to 370. As can be seen, the same equal spaced sample is retained that one would have retained if he had prior knowledge that 10 data points would be received, even though in FIG. 3 it was not known at any of the previous data points how many would ultimately be received. Of course, sometimes the “perfect knowledge” sample is just approximated using this technique. For example, had the process terminated with data point 8, the sample with “perfect knowledge” would have retained data points 3 and 6 whereas the sample at 350 retained data points 4 and 7. Furthermore, as described earlier, additional attributes may be considered in determining which data points to retain at a given time.

FIG. 5 illustrates a computer-readable medium for generating a visualization of a metric at a level of execution, according to an example. Computer 510 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to system 410, for example.

In addition, users of computer 510 may interact with computer 510 through one or more other computers, which may or may not be considered part of computer 510. As an example, a user may interact with computer 510 via a computer application residing on system 500 or on another computer, such as a desktop computer, workstation computer, tablet computer, or the like. The computer application can include a user interface (e.g., touch interface, mouse, keyboard, gesture input device).

Computer 510 may perform methods 100 and 200, and variations thereof. Additionally, the functionality implemented by computer 510 may be part of a larger software platform, system, application, or the like. For example, computer 510 may be part of a data analysis system.

Computer(s) 510 may have access to a database. The database may include one or more computers, and may include one or more controllers and machine-readable storage mediums, as described herein. Computer 510 may be connected to the database via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 520 may be at least one central processing unit (CPU), at least one semiconductor-based microprocessor, other hardware devices or processing elements suitable to retrieve and execute instructions stored in machine-readable storage medium 530, or combinations thereof. Processor 520 can include single or multiple cores on a chip, multiple cores across multiple chips, multiple cores across multiple devices, or combinations thereof. Processor 520 may fetch, decode, and execute instructions 532-536 among others, to implement various processing. As an alternative or in addition to retrieving and executing instructions, processor 520 may include at least one integrated circuit (IC), other control logic, other electronic circuits, or combinations thereof that include a number of electronic components for performing the functionality of instructions 532-536. Accordingly, processor 520 may be implemented across multiple processing units and instructions 532-536 may be implemented by different processing units in different areas of computer 510.

Machine-readable storage medium 530 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 530 can be computer-readable and non-transitory. Machine-readable storage medium 530 may be encoded with a series of executable instructions for managing processing elements.

The instructions 532-536 when executed by processor 520 (e.g., via one processing element or multiple processing elements of the processor) can cause processor 520 to perform processes, for example, methods 100 and 200, and/or variations and portions thereof.

Computer 510 may receive multiple data points from a stream of time series data. Computer 510 may store the multiple data points in a database or other storage. The data points may be stored until a limit is reached, such as a storage limit. Upon receiving an additional data point, determining instructions 532 may cause processor 520 to determine spaced intervals over the time series. Ranking instructions 534 may cause processor 520 to rank the data points based at least in part on their respective distance from their respective nearest spaced interval. The data points to be ranked may be a subset of the data points. For example, the first and last data point may be omitted from the data points to be ranked. Discarding instructions 536 may cause processor 520 to discard the highest ranked data point.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method comprising, by a processing system:
receiving a stream of time series data comprising multiple data points; and
while receiving the stream:
(1) storing each received data point until a limit is reached; and
(2) upon receiving each additional data point, performing a retention process as follows:
(a) retaining the first data point and the last data point;
(b) determining spaced intervals over the time series between the first and last data points;
(c) ranking each remaining data point, a data point's rank being based at least in part on the data point's distance from the data point's nearest spaced interval; and
(d) discarding a data point based on its ranking.

2. The method of claim 1, further comprising:
determining whether a data point has a characteristic, the data point's rank being based at least in part on whether the data point has the characteristic.

3. The method of claim 2, wherein the characteristic comprises one of being a maximum value in the time series, being a minimum value in the time series, and being an inflexion point in the time series.

4. The method of claim 2, wherein it is determined whether he data point has the characteristic by applying a function to the data point.

5. The method of claim 2, wherein it is determined whether the data point has any of multiple characteristics, each characteristic having an effect on the data point's ranking.

6. The method of claim 2, wherein the time series data is multivariate such that each data point comprises measurements for multiple metrics at a particular time, the data point's rank being based at least in part on whether any metric measurement of the data point has the characteristic.

7. The method of claim 2, wherein it is determined whether the data point has the characteristic at any of multiple levels of execution.

8. The method of claim 7, wherein the stream of time series data is received from a query engine, the time series data representing measurements of a metric related to execution of a query.

9. The method of claim 8, wherein the multiple levels of execution comprise at least two of a query level, a query phase level, a node level, a path level, and an operator level.

10. The method of claim 1, the retention process further comprising retaining the remaining data points.

11. The method of claim 1, wherein the spaced intervals are substantially equal spaced time intervals from the first data point in the time series to the last data point in the time series.

12. The method of claim 1, wherein the limit is a storage allocation limit.

13. The method of claim 1, wherein the data point farthest from its nearest spaced interval is assigned the highest rank.

14. A system comprising:
a database to store data points in a multivariate time series, the data points comprising measurements of metrics collected by a query execution engine during execution of a query;
a retention engine to determine which measurements to retain upon reaching a limit, the retention engine configured to perform a retention process upon receiving a new data point, the retention process comprising:
(a) retaining a first data point and a last data point;
(b) determining spaced intervals over the time series;
(c) ranking each remaining data point using a ranking function, the ranking function being configured to assign a rank to a data point based at least in part on the data point's distance from its nearest spaced interval;
(d) discarding the highest ranked data point; and
(e) retaining the remaining data points.

15. The system of claim 14, wherein the retention engine further configured to:
determine whether a data point has a characteristic, the ranking function being configured to assign a rank to a data point based at least in part on whether the data point has the characteristic.

16. The system of claim 14, further comprising:
an aggregator to aggregate the measurements of the metrics at multiple levels of execution of the query,
wherein the retention engine is further configured to determine whether a data point has the characteristic at any of multiple levels, the multiple levels comprising at least two of a query level, a query phase level, a node level, a path level, and an operator level.

17. A non-transitory computer-readable storage medium storing instructions for execution by a computer, the instructions when executed causing the computer to:
store multiple data points from a stream of time series data; and
upon receiving an additional data point from the stream:
(a) determine spaced intervals over the time series;
(b) rank data points based at least in part on their respective distance from their respective nearest spaced interval; and
(c) discard the highest ranked data point.
